(19) United States
(12) Patent Application Publication
(10) Pub. No.: US 2005/0072051 A1
(43) Pub. Date: Apr. 7, 2005

(54) Self-fastening glass attachment clip

(76) Inventors: Keith Pound, Troy, MI (US); Kim Margerum, Nashville, TN (US); Benjamin Mullinix, Bedford, TX (US)

Correspondence Address: CARLSON, GASKEY & OLDS, P.C., 400 WEST MAPLE ROAD, SUITE 350, BIRMINGHAM, MI, 48009, US

(21) Appl. No.: 10/677,197

(22) Filed: Oct. 2, 2003

(51) Int. Cl. B60J 1/16

(52) U.S. Cl. 49/375

(57) ABSTRACT

A self-fastening window attachment clip is disposed within a cursor attached to a window lift mechanism. The clip includes a locking portion engaged with an attachment member secured to a window and received within a slot of the cursor. The clip includes a locking portion and a biasing portion that secures the attachment member within the cursor. The clip is disposed within the cursor and orientated such that insertion of the attachment member flexes the locking portion out or the slot. With the attachment member in contact with the biasing portion, the locking portion is free to spring back across the slot and engage a top portion of the attachment member. The locking portion engages the attachment member and prevents removal of the attachment member from the slot of the cursor.

### BACKGROUND OF THE INVENTION

This invention generally relates to window lifting assembly and specifically to a self-fastening attachment clip for securing a window to a window lifting mechanism.

Conventional window lifting assemblies include a window attached to a lifting mechanism for moving the window between an open and closed position. Typically, the window is secured to a securing member, commonly referred to as a cursor that is in turn attached to the lifting mechanism. The lifting mechanism is in turn driven by an electric motor, or manually by rotation of a hand crank.

Typically, the window is secured to the lifting mechanism by an attachment member extending from the window that is locked within the cursor. The attachment member is often a bolt, a threaded rod or stud fastened to the window. During assembly, the attachment member is received within a slot of the cursor and secured therein. Attachment of the window to the lifting mechanism should be quick, efficient and cost effective in order to provide ease of assembly.

One example of a current device for securing a window to a lifting mechanism includes an elaborately molded cursor. The cursor includes an integrally molded clip that locks onto an attachment member secured to the window. The attachment member is a cylindrical stud that extends from the window. The integrally molded clip includes a pair of opposing legs that correspond to the shape of the attachment member. The window is received within a longitudinal slot in the cursor and the attachment member is received within a transverse slot. The attachment member expands the legs of the clip outward as it passes the clip. The legs than spring back into position to trap the attachment member within the cursor. Molded cursors of this type provide quick assembly. However, the intricate molding of the cursor may be expensive, and a relatively complex mold is required.

Accordingly, it is desirable to design a cost efficient, easily assembled attachment mechanism for securing a window to a lifter mechanism.

### SUMMARY OF INVENTION

An embodiment of this invention includes a window lift mechanism having a clip disposed within a cursor. A window having an attachment member is received within the cursor and the attachment member is locked within the cursor between a locking portion and a bias portion of the clip.

The window lift assembly includes a window secured within cursors supported on the lifting mechanism. The attachment member and the window are received within slots of the cursor. A locking portion and a biasing portion of the clip secures the attachment member to the cursor. The clip is disposed within the cursor and orientated such that insertion of the attachment member moves the locking portion out of the slot.

The attachment member moves downward within the slot until contacting the biasing portion of the clip. The locking portion of the clip springs back into a locking position once the attachment member has contacted the biasing portion. The locking portion engages the attachment member and prevents removal of the attachment member from the slot of the cursor.

Another clip according to the present invention is a single continuous resilient strand with first and second segments. The locking portion is adjacent the first segment and the biasing portion is adjacent the second segment. The locking portion moves aside as the attachment member and the window are received within the cursor. The locking member spring back into the locking position, preventing removal of the window. The bias portion biases the attachment member into engagement with the locking portion.

Accordingly, the window lift mechanism of this invention allows easy installation of a window to a lifting mechanism and positive retention of the window once secured with the cursor.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a plan view of a window lifter mechanism;

FIG. 2 is a perspective view of the cursor and window;

FIG. 3 is a perspective view of the window received within the cursor;

FIG. 4 is a is a side view of the clip

FIG. 5 is a front view of the clip;

FIG. 6A is a plan view of the back of the cursor;

FIG. 6B is a cross-sectional view of the cursor shown in FIG. 6A;

FIG. 6C is another cross-sectional view of the cursor shown in FIG. 6A;

FIG. 7A is a plan view of the back of another embodiment of the cursor;

FIG. 7B is a cross-sectional view of the cursor shown in FIG. 7A;

FIG. 8 is a schematic view of the attachment member engaged to a portion of the clip; and

FIG. 9 is a schematic view of the attachment member fully secured within the cursor by the clip

### DETAILED DESCRIPTION OF THE PREFERRED EMBODIMENT

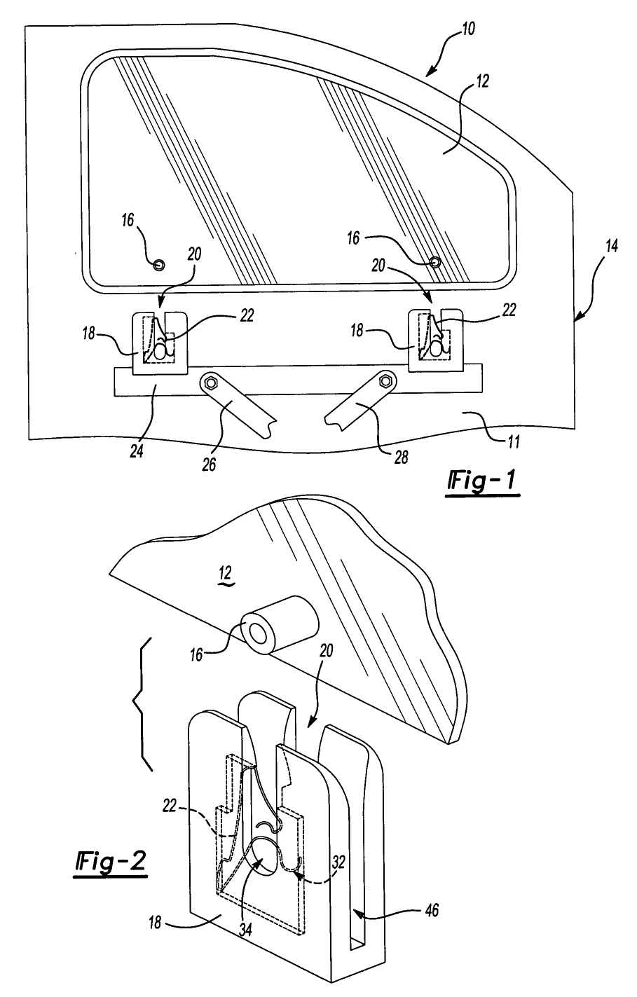

Referring to FIG. 1, a window lift assembly 10 includes a window 12 secured within cursors 18 supported on a lifting mechanism 14. The window lift mechanism is supported within a vehicle door 11. The window 12 includes at least one attachment member 16 received within a slot 20 of the cursor 18. The attachment member 16 is secured within the cursor 18 by a clip 22. The clip 22 includes a locking portion 32 and a biasing portion 34 that secures the attachment member 16 within the cursor 18.

The attachment member 16 extends perpendicularly from the window 12 and is received within slots 20 of the cursors 18. The cursors 18 are supported on the lifter mechanism 14. The lifter mechanism 14 includes a first member 24 that supports the cursors 18. Second and third members 26,28 are attached to the first member 24 and to additional lifting mechanisms (not shown) that are driven by an electric motor or by a hand crank as is known. As appreciated, the illustrated lift mechanism 14 is only an example of a lift mechanism compatible with this invention. Other lift mechanisms are also within the contemplation of this invention.

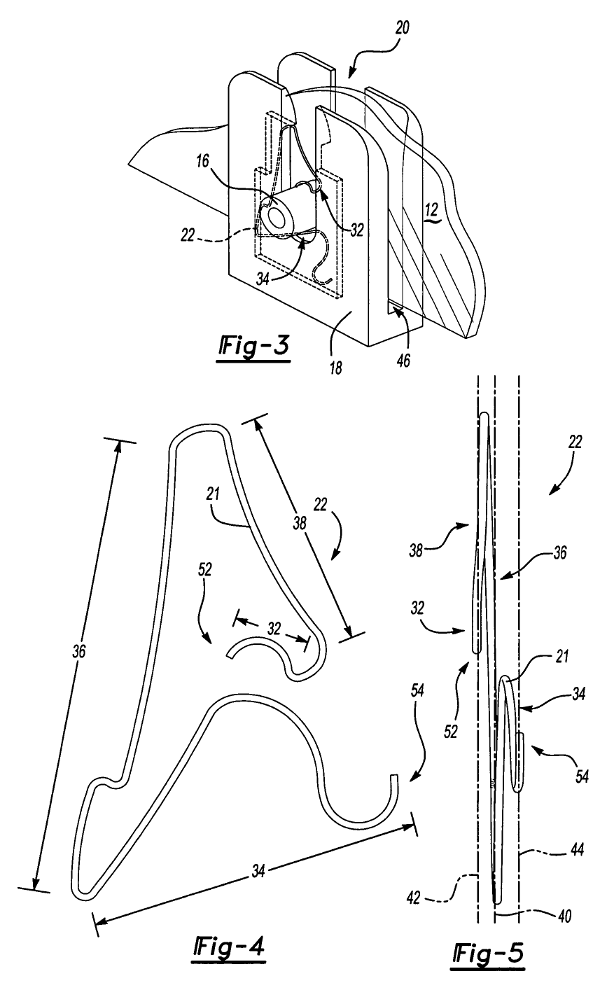

Referring to FIGS. 2 and 3, each cursor 18 includes a channel 46 for receiving the window 12 and a slot 20 for receiving the attachment member 16. The clip 22 is disposed within the cursor 18 and orientated such that insertion of the attachment member 16 bends the locking portion 32 out of the slot 20. The attachment member 16 is received within the slot 20 and contacts the biasing portion 34 of the clip 22. With the attachment member 16 in contact with the biasing portion 34, the locking portion 32 is free to spring back across the slot 20 and engages a top surface of the attachment member 16. The locking portion 32 preferably includes a profile corresponding to the attachment member 16. The locking portion 32 engages the attachment member 16 and prevents removal from the slot 200f the cursor 18.

Referring to FIGS. 4 and 5, the clip 22 includes a sliding portion 38 adjacent the locking portion 32. The sliding portion 38 and biasing portion 34 are separate elements attached by a body portion 36 of the clip 22. The clip 22 comprises a single continuous resilient strand 21 having first and second segments 50,52. The locking portion 32 is adjacent he first segment 52 and the bias portion 34 is adjacent the second segment 54. The clip 22 bends to allow the attachment member 16 to slide by the locking portion 32. The window 12 is received and locked within the cursor 18 by pushing the window 12 and attachment member 16 fully into the slot 20.

The body portion 36 connecting the locking portion 32 and the biasing portion 34 defines a first central plane 40. The locking portion 32 is angled away from the first central plane 40 and defines a second plane 42. Because the locking portion 32 is on a different plane than the body portion 36, the locking portion 32 can flex toward and past the body portion 36 to allow the attachment member 16 to pass within the slot 20 toward and into contact with the biasing portion 34. The biasing portion 34 defines a third plane 44 opposite the second plane 42 and different from the first center plane 40.

The position of the planes 40,42,44 of the clip 22 stabilizes the clip 22 within the cursor 18. It should be understood that the portions 34, 32 and 36 generally define a planar spatial relationship and need not be fully confined within a single plane.

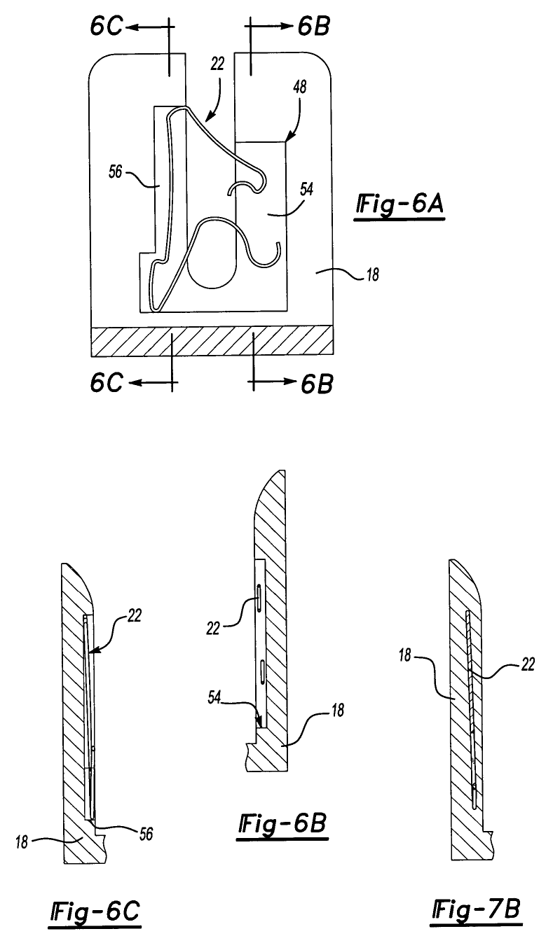

Referring to FIGS. 6A-C, a cursor 18 includes a cavity 48 adapted for retention of the clip 22. The clip 22 is positioned within the cavity 48 to prevent removal from the cursor 18 upward through the slot 20. The cavity 48 includes sections portions disposed on either side of the slot 20 that support the clip 22 and prevent upward movement and removal of the clip 22 from the slot 20.

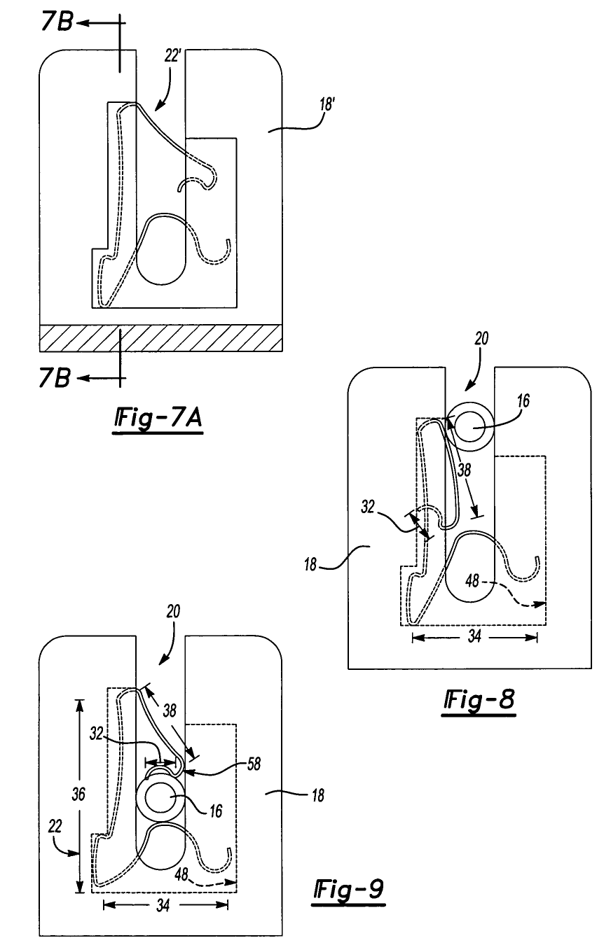

Referring to FIGS. 7A-B, another clip 22′ is molded into the cursor 18′ using known insert molding techniques. It is within the contemplation of this invention to use known molding techniques to secure the clip 22 within the cursor 18, for example, molded tabs, clips, or separate fasteners.

Referring to FIGS. 8 and 9, FIG. 8 illustrates initial entry of the attachment member 16 into the slot 20 and FIG. 9 illustrates locking of the attachment member 16 by the clip 22. In operation, the attachment member 16 moves within the slot 20 and contacts the slide portion 38 of the clip 22 to force the locking portion 32 aside and out of the slot 20. The sliding portion 38 is pushed aside by downward movement of the attachment member 16 within the slot 20. Because the locking portion 32 is on a different plane than the body portion 36 (FIG. 5), the locking portion 32 pushes past the body portion 36 to allow the attachment member 16 to be completely received within the slot 20. Once the attachment member 16 has passed the locking portion 32, the locking portion 32 springs back across the slot 20 to the original shape of the clip 22. Upward force on the window 12 and the attachment member 16 forces first and second corners 58,60 of the clip 22 into contact with surfaces of the cavity 48 of the cursor 18, preventing removal of the attachment member 16.

The attachment member 16 may be removed by moving the locking portion 32 aside with a tool such as a flat tipped screwdriver, to clear the slot 20. Removal of the window 12 is therefore possible for maintenance and repair by moving aside the locking portion 32 to clear the slot 20 from obstruction by the clip 22. However, with the locking portion 32 engaged, the attachment member 16 is not removable from the slot 20. Further, the attachment member 16 is trapped between the locking portion 32 and the biasing portion 34, providing a tight secure fit. The bias portion 34 biases the attachment member 16 into engagement with the locking portion 32, securing the attachment member 16 tightly within the cursor 18.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A window lift mechanism assembly comprising;
a window comprising at least one attachment member;
a cursor adapted to receive said attachment member; and
a clip disposed within said cursor comprising a locking portion and a bias portion, said locking portion and said bias portion securing said attachment member within said cursor.

2. The assembly of claim 1, wherein said clip comprises a single continuous resilient strand having first and second segments, said clip formed so as to have said locking portion adjacent said first segment and said bias portion adjacent said second segment.

3. The assembly of claim 2, further comprising a body portion connecting said locking portion and said bias portion, said body portion defining a first plane and said locking portion and said bias portion defining planes different from said first plane.

4. The assembly of claim 3, wherein said locking portion is on a second plane and said bias portion is on a third plane, said second and third planes disposed on opposite sides of said first plane.

5. The assembly of claim 1, wherein said locking portion includes a profile corresponding to the attachment member.

6. The assembly of claim 2, further comprising a slide portion engaged to move the locking portion aside until the attachment member is past the locking portion.

7. The assembly of claim 1, wherein the attachment member comprises a cylindrical projection extending perpendicularly from the window.

8. The assembly of claim 1, wherein the curser includes a slot for receiving the attachment member.

9. The assembly of claim 8, wherein the slot includes a cavity adapted for retention of said clip.

10. The assembly of claim 1, wherein said clip is not removable from said cursor.

11. The assembly of claim 1, wherein said attachment member slides downward into the cursor and is trapped between the locking portion and the bias portion of the clip.

12. The assembly of claim 1, wherein a portion of said clip is integrally molded into said cursor.

13. A door module assembly comprising:
a window lift mechanism;
a window including at least one attachment member;
a cursor attached to said window lift mechanism, said cursor comprising an opening to receive said attachment member; and
a clip disposed within said cursor, said clip comprising a locking portion and a bias portion, said locking portion and said bias portion securing said attachment member within said cursor.

14. The assembly of claim 13, wherein the clip comprises a single continuous resilient strand having first and second segments and formed so as to have said locking portion adjacent said first segment and said bias portion adjacent said second segment.

15. The assembly of claim 14, further comprising a body portion connecting said locking portion and said bias portion, said body portion defining a first plane and said locking portion and said bias portion defining planes different from said first plane.

16. The assembly of claim 15, wherein said locking portion defines a second plane and said bias portion defines a third plane, said second and third planes disposed on opposite sides of said first plane.
